(19) United States
(12) Patent Application Publication
(10) Pub. No.: US 2005/0160542 A1
(43) Pub. Date: Jul. 28, 2005

(54) Electromotion toothbrush rotatable in positive or reverse direction

(76) Inventor: Choong-hyun Jung, Gwangju-city (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/493,635

(22) PCT Filed: Oct. 11, 2002
(86) PCT No.: PCT/KR02/01909

(30) Foreign Application Priority Data
Oct. 24, 2001 (KR) 2001/65740

(51) Int. Cl. A61C 17/26

(52) U.S. Cl. 15/23

(57) ABSTRACT

The present invention relates to an electromotion toothbrush, and more particularly to an electromotion toothbrush which easily converts rotational direction thereof by simple manipulation of a switching circuit and easily removes foreign substances in gaps between teeth. For the purpose, the present invention comprises: a grip which can accommodate a driving motor for generating rotational force, a power supply for supplying power to the driving motor and a decelerator connected to the driving motor for decelerating the rotational speed of the output shaft of the driving motor; a direction conversion switch provided between the power supply and the driving motor for easily converting the rotational direction of the driving motor into a positive or reverse direction; a rotating toothbrush bar consisting of a rotating rod installed to the decelerator and a removable bristle part which is positioned on the rotating rod and on which toothbrush bristles are planted; and a removable protective stand installed at one side of the top of the grip parallel to the rotating toothbrush bar. The bristle part has longer bristles on the upper part, the middle and the lower part thereof, than that provided to the other parts.

### TECHNICAL FIELD

The present invention relates to an electromotion toothbrush, and more particularly to an electromotion toothbrush of which rotational direction is easily converted by the manipulation of direction conversion switching circuitry, which easily removes foreign substances between teeth and is convenient to carry.

### BACKGROUND ART

A toothbrush is a mouth-washing tool used to protect teeth, gaps between teeth, etc. from germs harmful to the human body, and is classified as either a manual toothbrush or an electromotion toothbrush, wherein a user holds the grip of the manual toothbrush and rotates the toothbrush in a given direction for operation thereof, and the electromotion toothbrush is rotated by an electromotor such as a driving motor.

Several types of toothbrushing can be performed using a conventional toothbrush.

Some of the uses of the manual toothbrush involve the “scraping method” in which a user brings the manual toothbrush into contact with teeth and then carries out a reciprocal motion thereof; the Bass method in which a user slants the toothbrush's bristles about 45 degrees and touches gaps between teeth, and then carries out a to-and-fro motion; and the method in which a user carries out an up-and-down motion or circular motion with respect to his/her teeth and gums with the manual toothbrush.

The methods described above, such as the Bass method, the up-and-down or circular motion method, etc., however, have a disadvantage that makes it difficult to properly brush teeth by means of a manual toothbrush. It is more difficult for a user who is accustomed to improper toothbrushing habits to obtain such a proper toothbrushing method. Moreover, the up-and-down and circular motions are very annoying even to an actually skillful user, so that, in most cases, toothbrushing is carried out only in a to-and-fro motion.

Consequently, since foreign substances cannot efficiently be removed, manual toothbrushing by the methods described above may injure a user's mouth, for example, causing inflammation on user's gums, due to wrong toothbrushing habits.

In order to overcome such disadvantages, electromotion toothbrushes, which are rotated by an electromotor such as a driving motor, have been developed.

Conventional electromotion toothbrushes have been invented for a simple motion or circular motion, wherein the electromotion toothbrush by a simple motion needs a small amount of user's physical force when toothbrushing but can not achieve efficient removal of foreign substances by means of a simple to-and-fro motion.

Most of the rotating electromotion toothbrushes rotate only in one direction, making this toothbrush inconvenient to use since a user has to alternate his/her hands to hold the toothbrush for brushing the upper and lower teeth in opposite directions.

Most conventional electromotion toothbrushes are also configured by an integrated type which does not allow replacement of toothbrush bristles, and are disadvantageous in that it can not properly protect parts in a user's mouth other than teeth, gaps between teeth, etc. through rotation of the toothbrush bristles.

A rotating electromotion toothbrush also has a disadvantage in that it cannot satisfactorily remove foreign substances between teeth. To this end, this style of toothbrushing needs a separate interdental toothbrush for removing interdental foreign substances.

An interdental toothbrush as shown in FIG. 5, however, requires a separate toothbrush for cleaning teeth because it can only clean gaps between teeth.

### DISCLOSURE OF INVENTION

The present invention is designed to solve the problems described above. Therefore, it is an object of the present invention to provide an electromotion toothbrush which can easily convert the rotational direction of a driving motor into a positive or reverse direction by the manipulation of direction conversion switching circuitry. It is another object of the invention to provide an electromotion toothbrush which implements easy removal of foreign substances between teeth and which a user can conveniently carry.

In order to achieve the objects described above, an electromotion toothbrush according to the present invention comprises: a grip which can accommodate a driving motor for generating rotational force, a power supply for supplying power to the driving motor and a decelerator connected to the driving motor for decelerating the rotational speed of the output shaft of the driving motor; a direction conversion switch provided between the power supply and the driving motor for easily converting the rotational direction of the driving motor into a positive or reverse direction by the manipulation of the direction conversion switching circuitry;, a rotating toothbrush bar consisting of a rotating rod installed to the decelerator and a removable bristle part which is positioned on the rotating rod and on which toothbrush bristles are planted; and a removable protective stand installed at one side of the top of the grip parallel to the rotating toothbrush bar.

The bristle part has longer bristles on the top part, the middle part and the bottom part than on any other area along the bristle part, or the toothbrush bristles are alternately planted at one side and then another side along the bristle part.

The electromotion toothbrush further comprises a toothbrush cover having at least one hole on its top side and a holder for easy transport at one external side.

### BRIEF DESCRIPTION OF THE DRAWINGS

These and other features, aspects, and advantages of the present invention will make it easier to understand with regards to the following descriptions, appended claims, and accompanying drawings. In the drawings:

FIG. 1 shows a perspective view of an electromotion toothbrush according to one embodiment of the present invention;

FIG. 2 shows a schematic diagram of a direction conversion switch of FIG. 1;

FIG. 3 shows a cross-section, partially enlarged, of a toothbrush bristle part of FIG. 1;

FIG. 4 shows a vertical cross-section of a toothbrush bristle part of an electromotion toothbrush according to another embodiment of the present invention; and

FIG. 5 shows a perspective view of a conventional interdental toothbrush.

### BEST MODE FOR CARRYING OUT THE INVENTION

Hereinafter, preferred embodiments of the present invention will be described in detail with reference to the accompanying drawings.

The following embodiment, however, is intended to illustrate the present invention, not to limit the scope of the invention. Simple changes and modifications in design of the invention can be easily implemented by those skilled in the art, and such changes and modifications are considered to be covered in the scope of the invention.

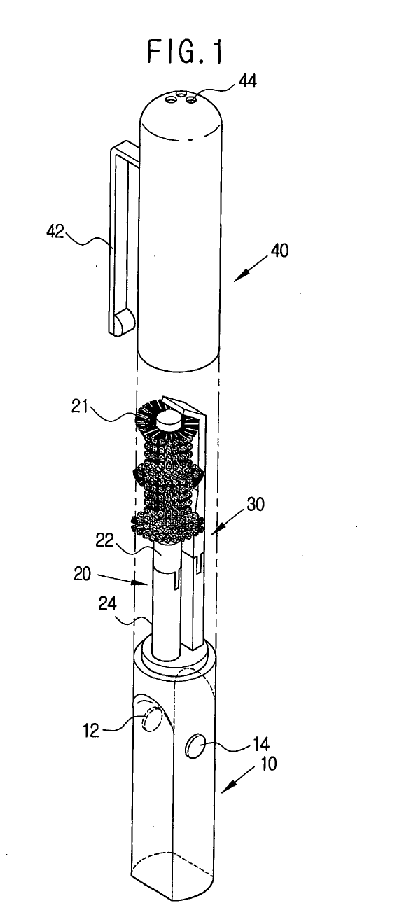

FIG. 1 shows a perspective view of an electromotion toothbrush according to one embodiment of the invention.

As shown in FIG. 1, the electromotion toothbrush according to the invention comprises a grip 10, direction conversion buttons 12 and 14, a rotating toothbrush bar 20, a protective stand 30 and a toothbrush cover 40.

The grip 10 is provided with a driving motor, a power supply and a decelerator (not shown) therein.

The power supply, which may be a dry cell or a storage battery, supplies power to the driving motor. The driving motor, which may be a DC motor, etc., receives power from the power supply to generate rotational force and then to transfer the force to the rotating toothbrush bar 20. The decelerator is coupled to the output shaft of the driving motor, and serves to decelerate the rotational speed. The decelerator may be a known gear assembly or a known clutch assembly, etc.

The direction conversion switches convert the rotational direction of the driving motor depending on the direction of the current supplied from the power supply, wherein the rotational direction of the driving motor is switched by means of the manipulation of the positive direction conversion button 12 and the reverse direction conversion button 14.

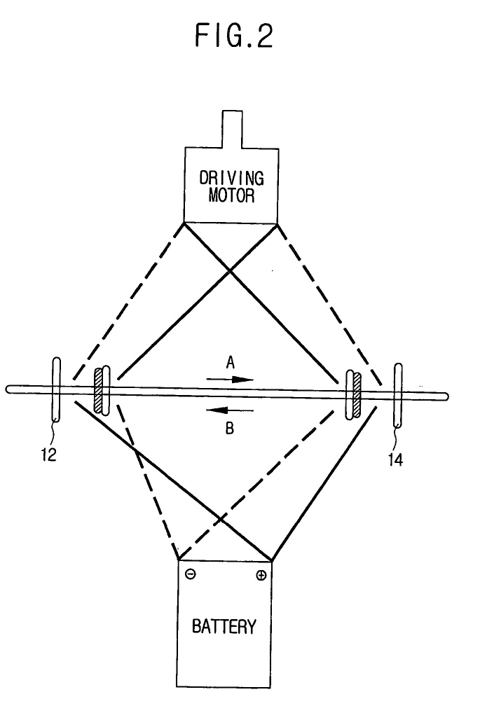

FIG. 2 is a schematic diagram to illustrate the mechanism between the power supply and the driving motor which switches the rotational direction by means of the direction conversion switches.

As shown in FIG. 2, if the positive direction conversion button 12 is pushed in the direction A, a positive current is applied to the left of the driving motor, and a negative current to the right thereof. Accordingly, the driving motor is rotated in the positive direction (the direction that the driving motor is rotated to the right if a user holds the grip with his/her right hand). In this case, an insulator is formed on the rear part of the reverse direction conversion switch 14 to prevent the inner switch thereof from being operated.

If the reverse direction conversion switch 14 is pushed in the direction B, a negative current is applied to the left of the driving motor, and a positive current to the right thereof. Accordingly, the driving motor is rotated in the reverse direction (opposite to the positive direction). In this case, an insulator is formed on the rear part of the positive direction conversion switch 12 to prevent the inner switch thereof from being operated.

The positive direction conversion button 12 is positioned at the left side of the grip 10 below the protective stand 30 while the reverse direction conversion switch 14 is positioned at an opposite side of the button 12 of the grip 10. Therefore, when a user wants to brush the upper teeth, all he/she has to do is to press the upper conversion button (i.e., the conversion button situated on the upper side of the grip during brushing of the teeth) for cleaning the upper teeth regardless of the location of the buccal or lingual side, the left or right, then the rotational direction of the bristle part 22 operates from gum to teeth, and when a user wants to brush the lower teeth, all he/she has to do is to press the lower conversion button (i.e., the button situated on the lower side of the grip during brushing of the teeth) for cleaning the lower teeth regardless of the location of the buccal or lingual side, the left or right. So that simple button operation is achieved.

The rotating toothbrush bar 20 comprises a bristle part 22 and a rotating rod 24.

The bristle part 22 is provided with insertion projections and the rotating rod 24 with insertion grooves, so that the bristle part 22 can be removably combined with the rotating rod 24. It is also possible that the insertion projections are provided to the rotating rod 24 and the insertion grooves to the bristle part 22. One or more insertion projections and insertion grooves may be provided.

It is also possible to form the lower part of the bristle part 22 in a female screw type and the upper part of the rotational part 24 in a male screw type such that the bristle part 22 can be removably combined with the rotating rod 24. It is also possible to form the lower part of the bristle part 22 in a male screw type and the upper part of the rotating rod 24 in a female screw type.

Since the bristle part 22 can be removed from the rotating rod 24, the bristles 21 can be replaced with new bristles if they are worn, or with bristles of a different stiffness.

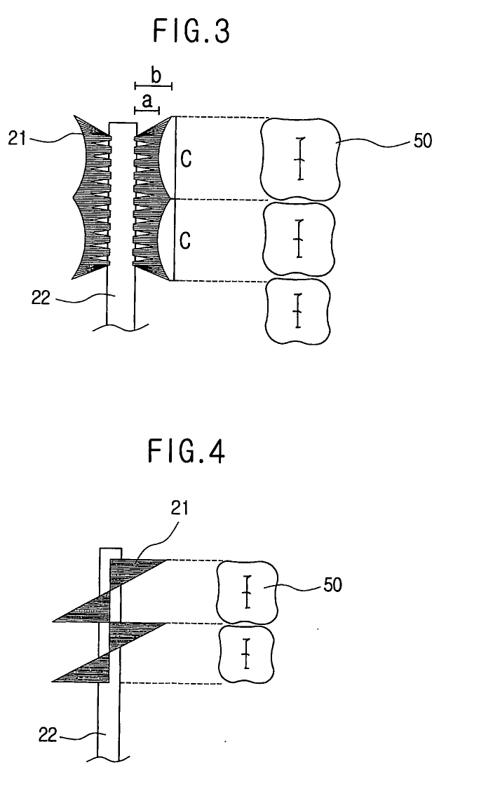

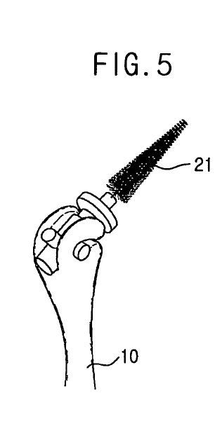

FIG. 3 shows a cross-section of the bristle part of an electromotion toothbrush, partially enlarged, according to one embodiment of the present invention.

As shown in FIG. 3, longer bristles 21 may be provided on the top part, the middle part and the bottom part of the bristle part 22, than that provided on the other areas. The bristles 21 may be planted onto the frame of the bristle part 22 to be 360 degrees round. Thereby, the bristle part 22 may be in the shape of a two-staged hour-glass (that is, [symbol] ).

Preferably, the shortest bristles (a) 21 are about 3 mm and the longest bristles (b) 21 are about 7 mm. That is, the difference between the longest and the shortest bristles 21 are about 4 mm. Because the width of the tooth from the buccal side to the lingual side is about 8 mm in a normal adult, the bristles can approach the gaps between teeth of 4 mm from the buccal side and also 4 mm from the lingual side when brushing the teeth.

It is preferable that the distance (c) between the top part and the middle part, and between the middle part and the bottom part of the bristle part 22 is about 10 mm. Since the distance between a gap and its neighboring gap is about 10 mm as shown in FIG. 3, wherein the gap is a space between teeth, it is intended to clean the gaps with the longer bristles of the bristles 21.

FIG. 4 shows a vertical cross-section of the bristle part of an electromotion toothbrush according to another embodiment of the present invention.

As shown in FIG. 4, the bristles 21 are alternately provided on one side and then another side of the bristle part 22, and the shape may be saw-toothed. In the saw-tooth-shaped bristle part 22, the distance between the parts with longest bristles is preferably 10 mm along each side. Since the bristles 21 of the saw-toothed bristle part 22 do not touch the user's gums continuously unlike a general cylindrical toothbrush, burns on the gums can be prevented and this type of toothbrush is suitable for a person with weak gums in particular.

The protective stand 30 prevents the rotating bristles 21 from hurting other parts than the teeth and gums, e.g., the user's cheek at the buccal side or the tongue at the lingual side. The protective stand 30 is removably installed at one side on top of the grip 10 parallel to the rotating toothbrush bar 20. The protective stand 30 can be installed or removed in the same way as that for the rotating toothbrush bar 20.

The electromotion toothbrush may be further provided with a toothbrush cover 40 for protecting the rotating toothbrush bar (20) and the protective stand 30.

FIG. 1 further shows a part of the toothbrush cover. As shown in FIG. 1, at least one hole 44 is provided on the top part of the toothbrush cover 40, and a holder 42 for easy transport is provided at one side of the outer surface of the cover. The hole 44 is provided for hygienic reasons so that the bristle part 22 does not get damp while the toothbrush cover 40 is closed, in order to prevent germs from proliferating.

It is also possible to provide a toothbrush with a fine appearance by designing the outside of the toothbrush cover with famous characters or figures, etc.

By the aforementioned electromotion toothbrush according to the present invention, a direction conversion switch which is installed between the power supply and the driving motor implements easy rotational direction switching of the driving motor into a positive or reverse direction by means of the manipulation of the direction conversion switching circuitry, and an electromotion toothbrush is obtained for easy removal of foreign substances on teeth and in gaps between the teeth and for easy transport thereof.

The electromotion toothbrush according to the present invention is also provided with a direction conversion switch that makes the bristle part properly rotate depending on the intraoral location of the teeth.

The bristle part of the electromotion toothbrush according to the present invention can also be replaced, and thus the toothbrush body of the present invention can be used semi-permanently.

The electromotion toothbrush according to the present invention can also protect the intraoral part other than those for toothbrushing such as teeth, gaps between the teeth and the like, in toothbrushing.

The electromotion toothbrush according to the present invention is also very hygienic.

The electromotion toothbrush according to the present invention provided with a cover on the upper part thereof gives the toothbrush fine appearance, and is easy to transport and is hygienic.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. An electromotion toothbrush, comprising:
a grip for accommodating a driving motor for generating rotational force, a power supply for supplying power to the driving motor, and a decelerator connected to the driving motor for decelerating rotational speed of the output shaft of the driving motor therein;
a direction conversion switch provided between the power supply and the driving motor for easily converting the rotational direction of the driving motor into a positive or reverse direction by the manipulation of direction conversion switching circuitry;
a rotating toothbrush bar consisting of a rotating rod installed to the decelerator and a removable bristle part which is positioned on the rotating rod and on which toothbrush bristles are planted; and
a removable protective stand installed at one side of the top of the grip in parallel with the rotating toothbrush bar.

2. The electromotion toothbrush of claim 1, wherein the bristle part has longer bristles formed on its top, middle and bottom parts than those formed on the other parts.

3. The electromotion toothbrush of claim 2, wherein the shortest bristles are about 3 mm and the longest bristles are about 7 mm, and the distance between the top part and the middle part, and between the middle part and the bottom part of the bristle part is about 10 mm.

4. The electromotion toothbrush of claim 1, wherein the toothbrush bristles are alternately planted on opposite sides thereof.

5. The electromotion toothbrush of claim 1, further comprising a toothbrush cover having at least one hole on top thereof and a holder 42 for easy transport at one side of the outer surface thereof, for covering the rotating toothbrush bar and the protective stand.

6. The electromotion toothbrush of claim 2, further comprising a toothbrush cover having at least one hole on top thereof and a holder 42 for easy transport at one side of the outer surface thereof, for covering the rotating toothbrush bar and the protective stand.

7. The electromotion toothbrush of claim 3, further comprising a toothbrush cover having at least one hole on top thereof and a holder 42 for easy transport at one side of the outer surface thereof, for covering the rotating toothbrush bar and the protective stand.

8. The electromotion toothbrush of claim 4, further comprising a toothbrush cover having at least one hole on top thereof and a holder 42 for easy transport at one side of the outer surface thereof, for covering the rotating toothbrush bar and the protective stand.
